(19) United States
(12) Patent Application Publication
(10) Pub. No.: US 2019/0271174 A1
(43) Pub. Date: Sep. 5, 2019

(54) Defense Doorjamb Lock

(71) Applicant: Randy L. Van Kampen, North Las Vegas, NV (US)

(72) Inventor: Randy L. Van Kampen, North Las Vegas, NV (US)

(21) Appl. No.: 15/911,135

(22) Filed: Mar. 4, 2018

(51) Int. Cl. E05B 15/02; E05B 85/04; E05B 65/06

(52) U.S. Cl. CPC E05B 15/0205; E05B 65/06; E05B 85/04

(57) ABSTRACT

A device with a reinforcement plate implement, wherein said reinforcement plate implement is configured to position between a doorjamb and a doorframe stud, in which said reinforcement plate implement is operable for improving a resistance of the doorjamb from external force. A projecting lip segment is configured to rest on a middle portion of the doorjamb. A reinforcement plate aperture portion and a deadbolt strike plate implement are configured to accept the deadbolt of the lock mechanism. A reinforcement plate projecting tab part that lines a sidewall of said reinforcement plate aperture portion, interlocks with the deadbolt strike plate projecting tab part when the reinforcement plate implement is positioned between the doorjamb and the doorframe stud.

### CROSS-REFERENCE TO RELATED APPLICATIONS

Not applicable.

### RELATED CO-PENDING U.S. PATENT APPLICATIONS

Not applicable.

### INCORPORATION BY REFERENCE OF SEQUENCE LISTING PROVIDED AS ATEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to doorjamb reinforcement devices. More particularly, certain embodiments of the invention relate to a doorjamb device that is configured to improve the resistance of a door from external force, thus preventing a common method of forced entry that precedes burglary and other crimes.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

A typical method used by burglars and strong-arm men of entering residences and other buildings is a simple kick to a door near the bolt or latch. Since the striker plate is usually merely bolted to the doorjamb, a well-placed kick will usually break the striker plate from the doorjamb, fracturing the jamb in the process and allowing the door to fly open. The striker plate is generally positioned invariably along the edge of the jamb which the striker plate is supposed to reinforce.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that typical striker plates in buildings or homes may not pose a deterent to unauthorized entry. An unauthorized entry may be achieved by kicking the door and splitting the door jamb, dislodging the striker plate or prying the door and jamb apart to disengage a door latch from a striker plate, or cutting the door latch with loose fitting doors and jambs.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustration of an exemplary defense doorjamb lock device, in accordance with an embodiment of the present invention;

FIG. 2 is an illustration of an exemplary reinforcement plate, in accordance with an embodiment of the present invention;

FIG. 3 is an illustration of an exemplary deadbolt strike plate, in accordance with an embodiment of the present invention;

FIG. 4 is an illustration of an exemplary implementation of the reinforcement plate, in accordance with an embodiment of the present invention;

FIG. 5 is an illustration of an exemplary application of the reinforcement plate, in accordance with an embodiment of the present invention;

FIG. 6 is an illustration of an exemplary installation template indicating specific points of screw apertures in a doorjamb, in accordance with an embodiment of the present invention;

FIG. 7 is an illustration of an exemplary doorjamb with screw apertures, in accordance with an embodiment of the present invention;

FIG. 8 is an illustration of an exemplary installation of the deadbolt strike plate, in accordance with an embodiment of the present invention;

FIG. 9 is an illustration of an exemplary installation of the reinforcement plate and deadbolt strike plate, in accordance with an embodiment of the present invention;

FIG. 10 is an illustration of an exemplary flowchart to be use to install the defense doorjamb lock device, in accordance with an embodiment of the present invention; and

FIG. 11 is an illustration of an exemplary door with the defense doorjamb lock device, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of Claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising” And “contain” and variations of them—Such terms are open-ended and mean “including but not limited to”. When employed in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—or example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. sctn. 112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

All terms of exemplary language (e.g., including, without limitation, “such as”, “like”, “for example”, “for instance”, “similar to”, etc.) are not exclusive of any other, potentially, unrelated, types of examples; thus, implicitly mean “by way of example, and not limitation . . . ”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Moreover, any claim limitation phrased in functional limitation terms covered by 35 USC § 112(6) (post AIA 112(f)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s).

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components is described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

In an embodiment, the “Defense Doorjamb Lock” includes a reinforcement plate for positioning between a doorjamb and doorframe stud and an accompanying deadbolt strike plate. The reinforcement plate and the deadbolt strike plate feature projecting tabs that line the aperture through which a deadbolt projects. The reinforcement plate and deadbolt strike plate, and their extending tabs may substantially improve the resistance of a doorjamb from external force, thus preventing a common method of forced entry that precedes burglary and other crimes. Each plate features an aperture through which a deadbolt may enter, each plate further features a projecting tab that lines one (1) sidewall of each aperture. Wherein the reinforcement plate tab and deadbolt strike plate tab extends perpendicularly from its deadbolt hosting aperture. And wherein the reinforcement plate tab and deadbolt strike plate tab interlocks.

In some embodiments, the “Defense Doorjamb Lock” is made of a tool steel alloy including, but not limited to, carbon, tungsten and manganese The reinforcement plate may measure sixteen inches in length and three and one-half inches in width (16″×3½″) and is of a sixteen (16) gauge depth. Extending perpendicularly from one (1) length wall of the reinforcement plate is a lip of five-eighths of an inch (⅝″) in width. Featured in the base portion of the reinforcement plate are nine (9) apertures for screw insertion and an aperture for deadbolt acceptance. The deadbolt aperture may measure approximately one inch in length by three-quarters of an inch in width (1″×¾″). Within the aperture and attached to and extending perpendicularly from a length-wall of said aperture, is an extending tab. The deadbolt strike plate may measure approximately two and one-quarter inches in length by one and one-quarter inches in width (2¼″×1¼″). Centered within the deadbolt strike plate is an aperture for accommodation of the deadbolt. Within the aperture, and attached to and extending perpendicularly from a length-wall of said aperture, is an extending tab. The length planes above and below the aperture of the deadbolt strike plate each feature a single aperture for screw insertion. The screw apertures are length and width centered in those areas. Eleven (11) screws are included for the mounting of the reinforcement plate and the deadbolt strike plate. An installation template, indicating specific points of screw apertures and deadbolt apertures, are printed on a board. The board comprises of, but not limited to, paper or plastic material.

In other embodiments, the “Defense Doorjamb Lock” may be made of different materials that provide the strength and tension-resistance required to achieve its purpose, such as but not limited to tool steel, stainless steel and titanium. The “Defense Doorjamb Lock” may be made in various sizes and shapes in which it may fully fit between a doorjamb and door stud without extending beyond those planes and without interference of the operation of the door and its deadbolt. The deadbolt strike plate of the “Defense Doorjamb Lock” may be made in variations to accommodate the exact size of the deadbolt which it will accept in application. The “Defense Doorjamb Lock” may include various coatings and/or finishes that protect and/or protect appearance of the device. It may also include various prints and logos, for aesthetic appearance. The “Defense Doorjamb Lock” may be made in variations that accommodate, or are specifically made for use with, particular deadbolts and door-lock mechanisms. In such variations, such deadbolts and/or door-lock mechanisms may be included in a final packaging of the “Defense Doorjamb Lock”. The “Defense Doorjamb Lock” may include various quantities of apertures for screw-mounting of its deadbolt strike plate and reinforcement plate.

In alternate embodiments, The “Defense Doorjamb Lock” may or may not include screws for its application in final packaging. The “Defense Doorjamb Lock” may or may not include an installation drive bit in its final packaging. The “Defense Doorjamb Lock” may or may not include a template for installation in its final packaging. The “Defense Doorjamb Lock” may include devices such as wedges, and for aid in separating the doorjamb and the door frame stud in order to more easily insert the reinforcement plate, in its final packaging. The “Defense Doorjamb Lock” may include devices such as shims, and for aid in a secure placement of the reinforcement plate between the door frame stud and doorjamb. The “Defense Doorjamb Lock” may help prevent home invasions, burglaries and other crimes by blocking a common method of forcible entry.

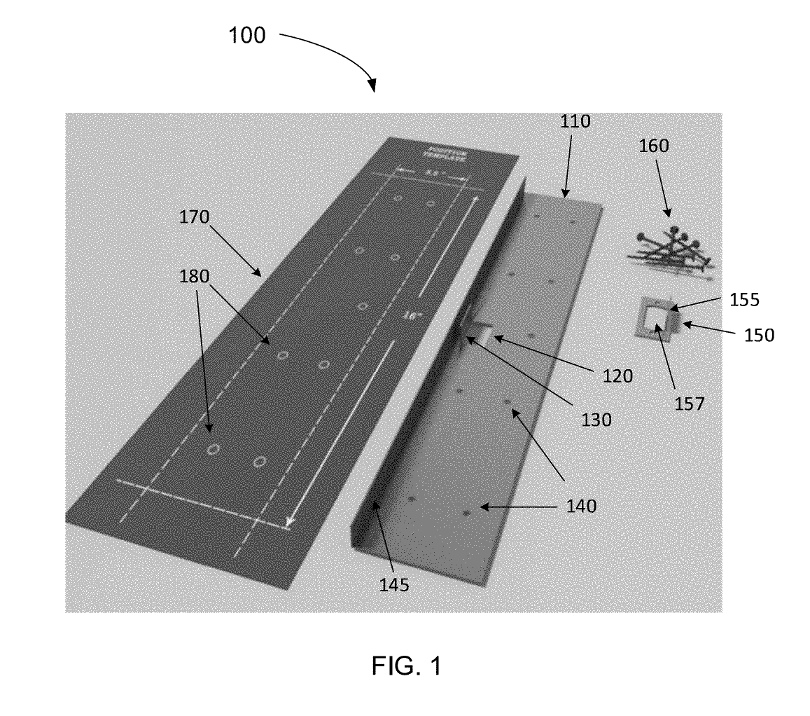

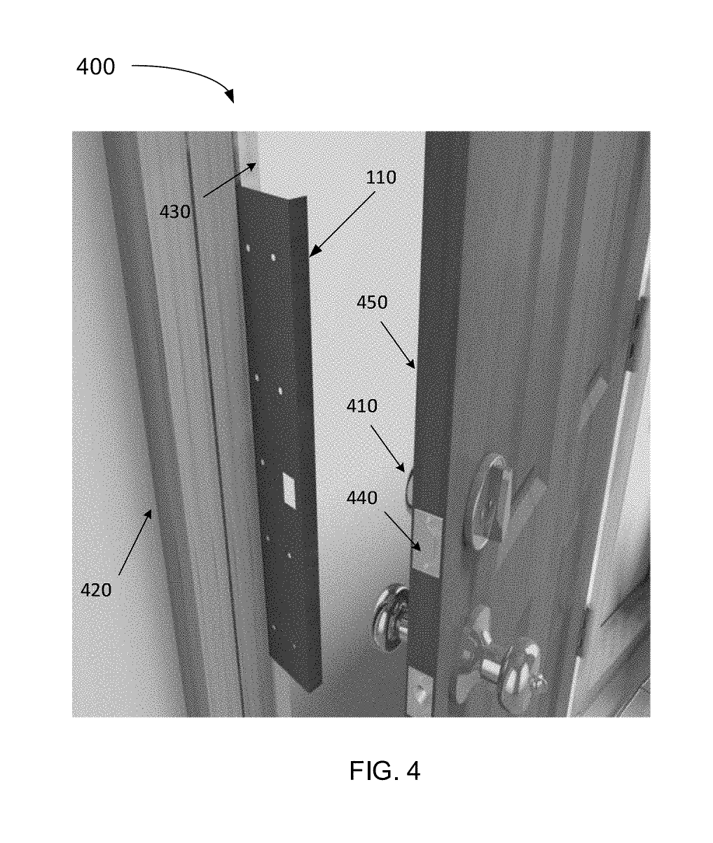

FIG. 1 is an illustration of an exemplary defense doorjamb lock device 100, in accordance with an embodiment of the present invention. In the present embodiment, a reinforcement plate implement 110 for positioning between a doorjamb and doorframe stud and a deadbolt strike plate implement 150 is shown. The reinforcement plate implement 110, deadbolt strike plate implement 150, reinforcement plate extending tab part 130, and a deadbolt strike plate projecting tab part 155 may substantially improve the resistance of a doorjamb from an external force, thus, it may prevent a common method of forced entry that precedes burglary and other crimes. The reinforcement plate implement 110 may feature a projecting lip segment 145 along one (1) length-wall, a reinforcement plate aperture portion 120 through which a deadbolt may enter, a reinforcement plate projecting tab part 130 that lines one (1) sidewall of the reinforcement plate aperture portion 120, and a plurality of reinforcement plate securing holes 140 for receiving the screws to secure the reinforcement plate implement when installed between a doorjamb and door stud. The deadbolt strike plate implement 150 includes a deadbolt strike plate aperture portion 157 through which the deadbolt may enter and a deadbolt strike plate projecting tab part 155 that lines one (1) sidewall of the deadbolt strike plate aperture portion 157. A set of screws 160 and an installation template implement 170 having a diagram format bearing the positions 180 of screws 160 for the reinforcement plate 110 and of the deadbolt strike plate 150 is included. In some embodiments, the defense doorjamb lock device 100 may substantially improve the force resistance of a deadbolt that projects through its deadbolt strike plate 150 and reinforcement plate 110. The defense doorjamb lock device 100 may substantially improve the force and pressure from kicks, shoulder thrusts, and other force-applied methods of entry. Whereas door security bars are easily capable of being kicked in, as they do not have firm attachment to the floor. In other embodiments, the defense doorjamb lock device 100 may be fixed within the doorjamb 430 (FIG. 4) and may improve the durability and resistance of a doorjamb 430 and doorframe stud 420 (FIG. 4).

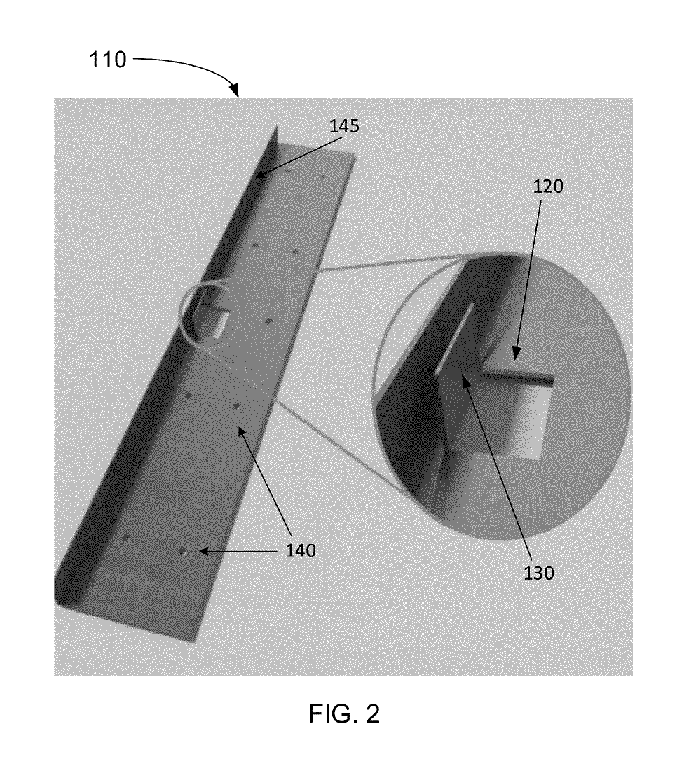

FIG. 2 is an illustration of an exemplary reinforcement plate device 110, in accordance with an embodiment of the present invention. In the present embodiment, a blown-up view of the reinforcement plate extending tab part 130 and reinforcement plate aperture portion 120 is shown.

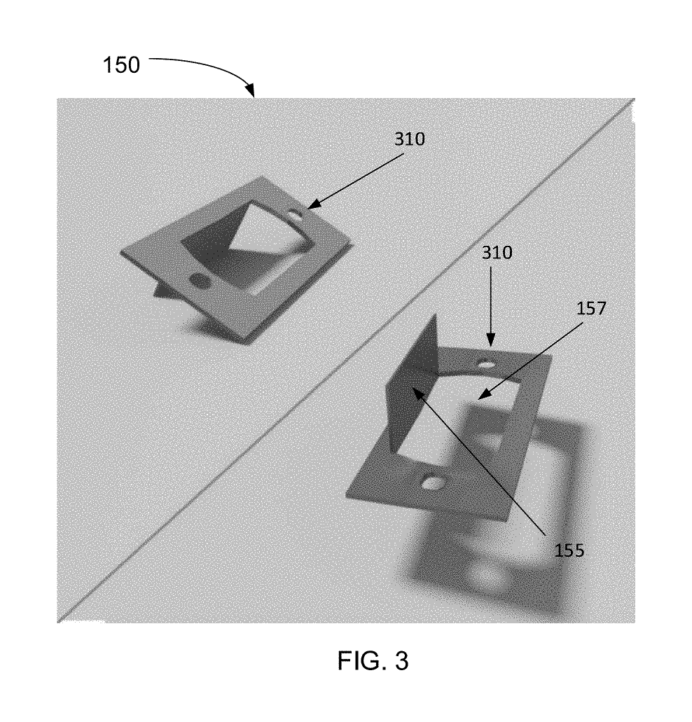

FIG. 3 is an illustration of an exemplary deadbolt strike plate device 150, in accordance with an embodiment of the present invention. In the present embodiment, a blown-up view of a proximate front and back portion of the deadbolt strike plate 150 is presented. The deadbolt strike plate device 150 includes the deadbolt strike plate aperture portion 157, the deadbolt strike plate projecting tab part 155 that lines one (1) sidewall of the deadbolt strike plate aperture portion 157 and two (2) aperture portions 310 for engaging the deadbolt strike plate device 150 to a doorjamb 430 (FIG. 4) with screw 160.

FIG. 4 is an illustration of an exemplary implementation 400 of the reinforcement plate 110, in accordance with an embodiment of the present invention. In the present embodiment shown, the reinforcement plate 110 being inserted between the doorjamb 430 and doorframe stud 420 to match a corresponding deadbolt 440 of a door 450 with a lock mechanism 410.

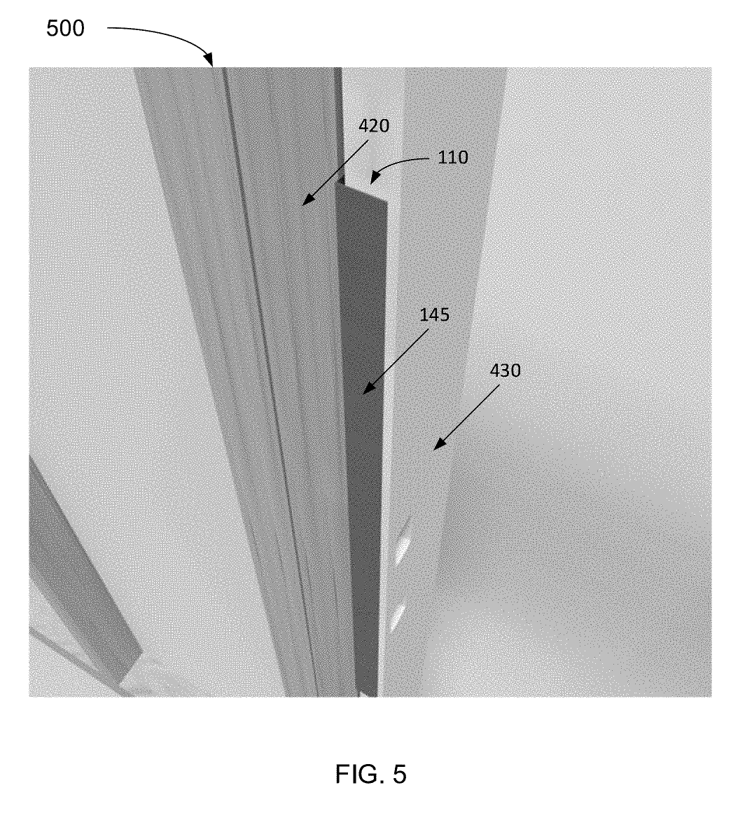

FIG. 5 is an illustration of an exemplary application 500 of the reinforcement plate 110, in accordance with an embodiment of the present invention. In the present embodiment provided, the reinforcement plate 110 is inserted and set between the doorjamb 430 and doorframe stud 420 with the projecting lip segment 145 of the reinforcement plate 110 resting along a portion of the doorjamb 430.

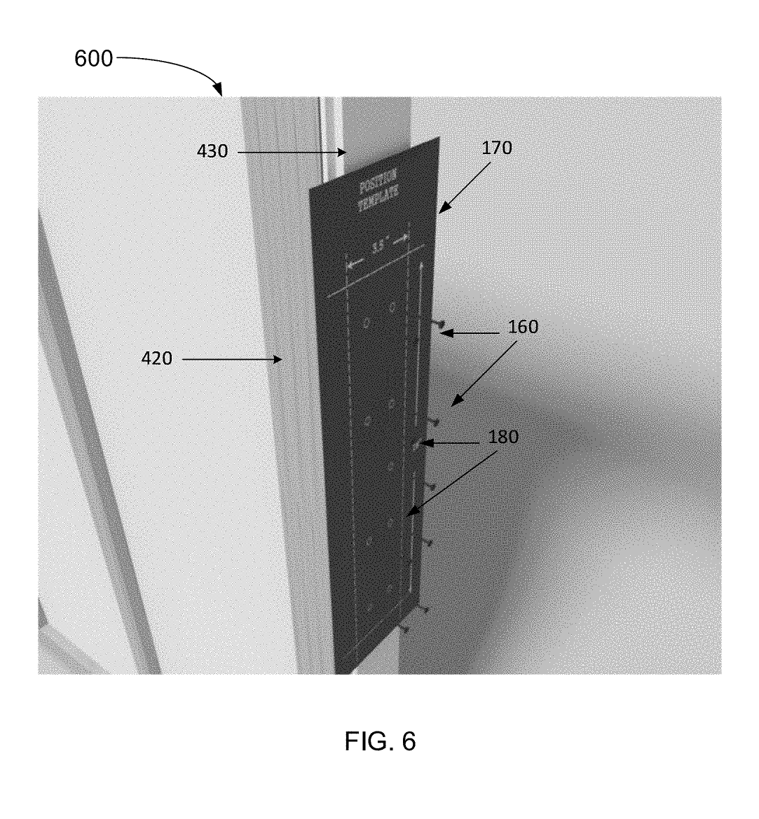

FIG. 6 is an illustration of the exemplary installation template 170 indicating specific points of screw apertures 180 in the doorjamb 430, in which screws 160 are installed, in accordance with an embodiment 600 of the present invention. In the present embodiment, the screws 160 are configured to secure the reinforcement plate 110 and the deadbolt strike plate 150 inserted between the doorjamb 430 and doorframe stud 420.

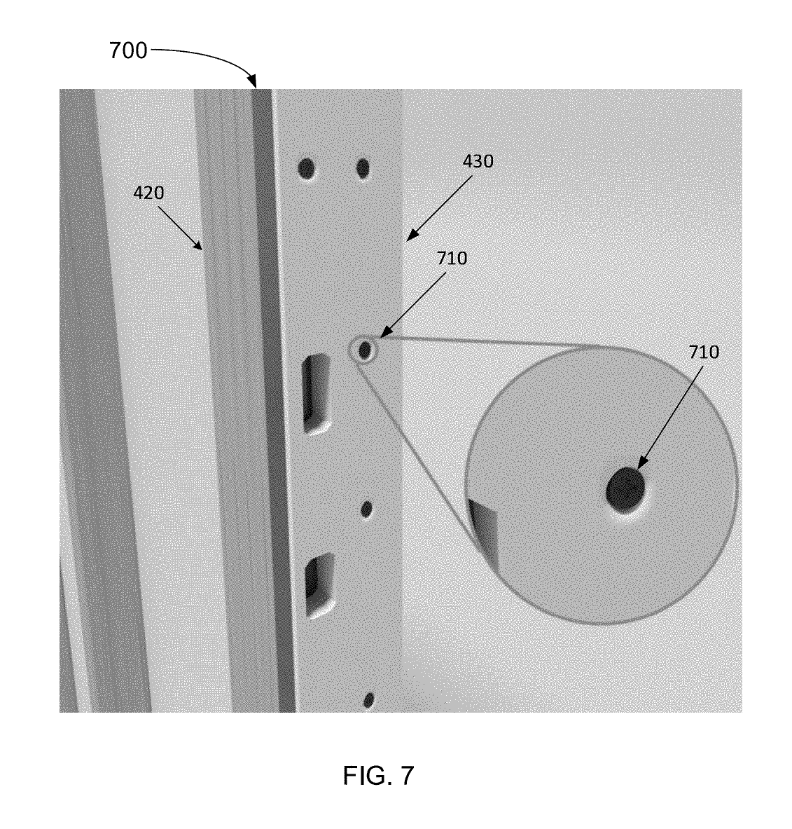

FIG. 7 is an illustration of an exemplary doorjamb 430 with screw holes 710, in accordance with an embodiment 700 of the present invention. In the present embodiment, a user may use a drill to create screw holes 710 as indicated on the installation template 170.

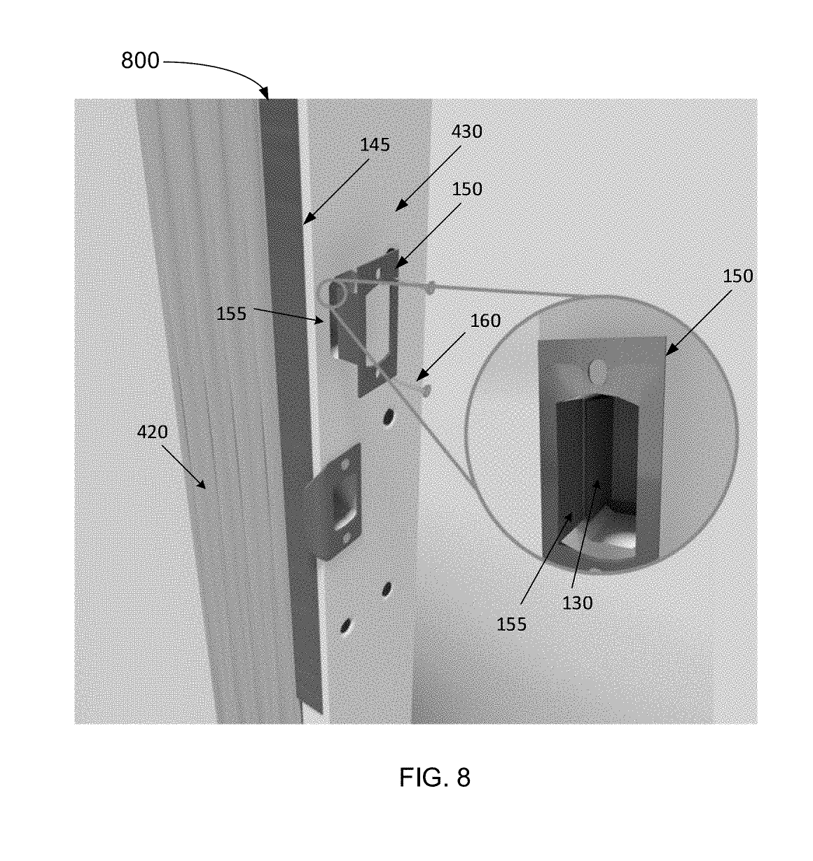

FIG. 8 is an illustration of an exemplary installation of the deadbolt strike plate 150, in accordance with an embodiment 800 of the present invention. In the present embodiment, the deadbolt strike plate 150 replaces a strike plate currently being used at a doorway. The deadbolt strike plate 150 may be applied, interlocking the deadbolt strike plate projecting tab part 155 with the reinforcement plate extending tab part 130, and secured by screws 160.

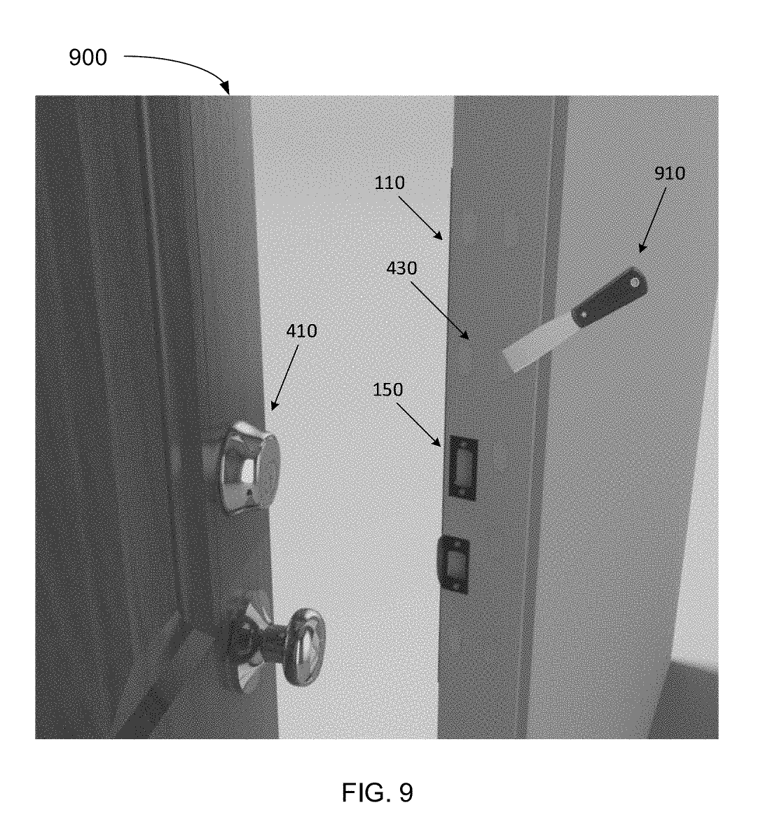

FIG. 9 is an illustration of an exemplary installation of the reinforcement plate 110 and deadbolt strike plate 150, in accordance with an embodiment 900 of the present invention. In the present embodiment, a shim 910 may be included to aid in the secure placement of the reinforcement plate 110 between the door frame stud 420 and doorjamb 430.

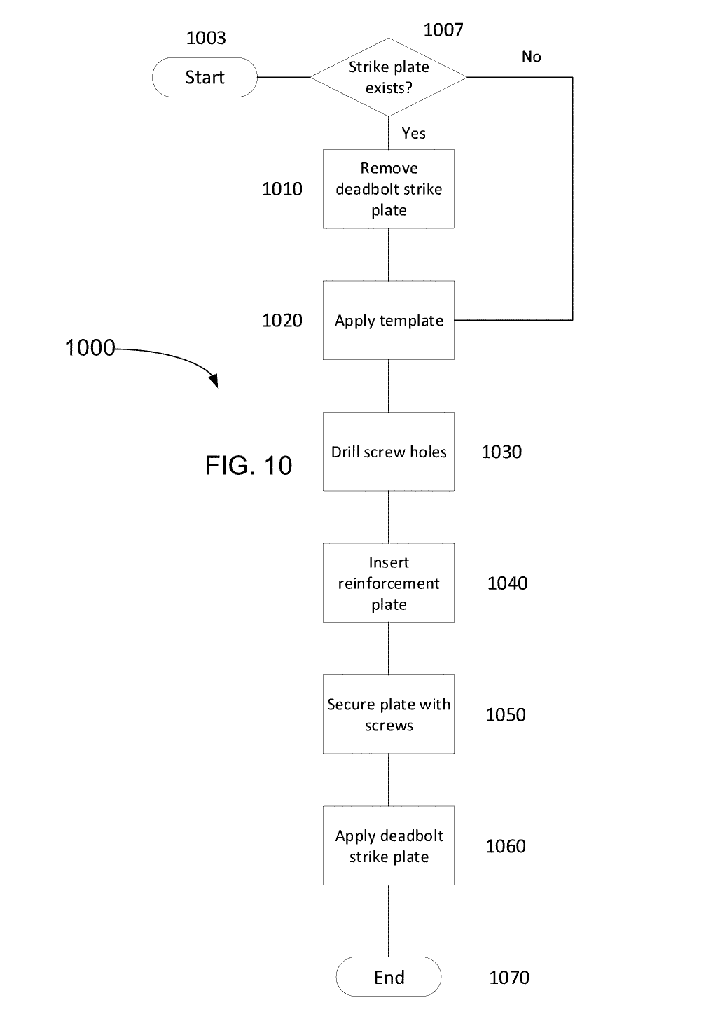

FIG. 10 is an illustration of an exemplary flowchart 1000 showing a method or process for installing the defense doorjamb lock device 100 in an existing door, in accordance with an embodiment of the present invention. In the present embodiment, the process starts at 1003. If a strike plate exists at the doorjamb of a door (e.g. existing door to improve security), in step 1010, remove the door strike plate currently in use. If no strike plate exists (e.g. door is new for installation of the defense doorjamb lock device 100), in step 1020, apply the installation template 170 indicating specific points of screw apertures 180 in the doorjamb 430, in which screws 160 will be installed. In step 1030, drill screw holes as indicated in the installation template 170. In step 1040, after marginally separating the doorjamb 430 from the door frame stud 420, the user may then insert the reinforcement plate 170 within that gap, ensuring alignment of the recently-created screw holes to those of the reinforcement plate 110. In step 1050, the reinforcement plate 110 may then be secured by application of its screws 160. In step 1060, the deadbolt strike plate portion 150 of the defense doorjamb lock device 100 may then be applied, interlocking deadbolt strike plate tab part 155 with the reinforcement plate tab part 130, as shown in FIG. 8, and secured by screws. Process ends in step 1070.

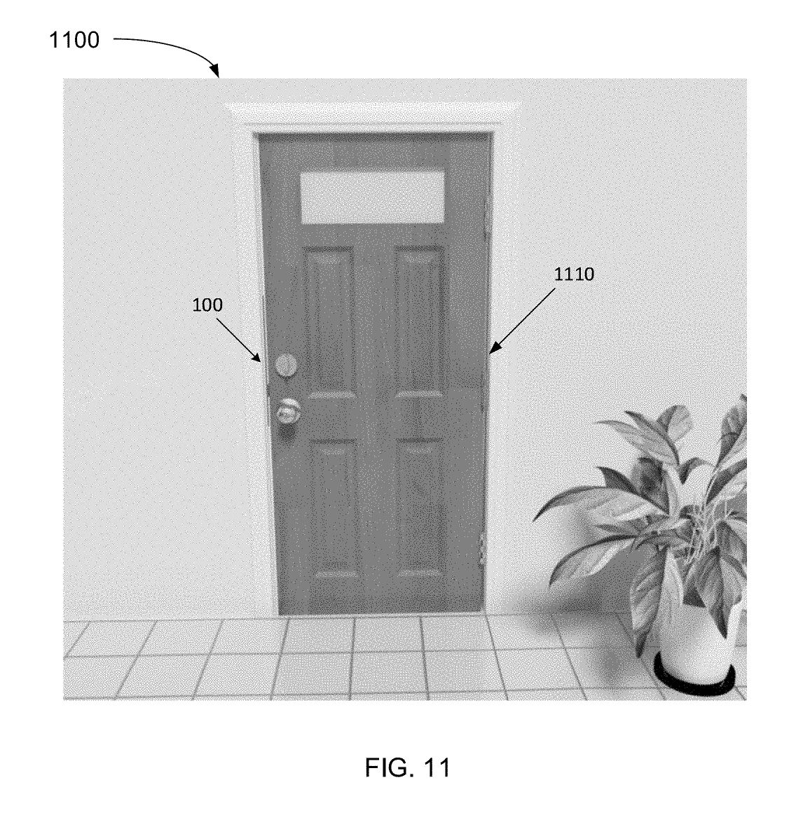

FIG. 11 is an illustration of an exemplary door with the defense doorjamb lock device 100, in accordance with an embodiment 1100 of the present invention. In the present embodiment shown, the door 1110 may be comforted by the improved security offered by the defense doorjamb lock device 100.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post AIA 112(f)) when such corresponding structures are not explicitly disclosed in the foregoing patent specification. Therefore, for any invention element(s)/structure(s) corresponding to functional claim limitation(s), in the below claims interpreted under 35 USC § 112(6) (post AIA 112(f)), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112(6) (post AIA 112(f)) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing a doorjamb device that is configured to improve the resistance of a door from external force according to the present invention will be apparent to those skilled in the art. Various aspects of the invention have been described above by way of illustration, and the specific embodiments disclosed are not intended to limit the invention to the particular forms disclosed. The particular implementation of the doorjamb device that is configured to improve the resistance of a door from external force and may prevent a common method of forced entry that precedes burglary and other crimes, may vary depending upon the particular context or application. By way of example, and not limitation, the doorjamb device that is configured to improve the resistance of a door from external force described in the foregoing were principally directed to door resistance implementations; however, similar techniques may instead be applied to windows, trap doors, basement doors, etc., which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

What is claimed is:

1. A device comprising:
a reinforcement plate implement, wherein said reinforcement plate implement is configured to position between a doorjamb and a doorframe stud, in which said reinforcement plate implement is operable for improving a resistance of the doorjamb from external force;
a projecting lip segment, wherein said projecting lip segment is configured to rest on a proximate middle portion of the doorjamb;
a reinforcement plate aperture portion, wherein said reinforcement plate aperture portion is configured to accept a deadbolt of a lock mechanism; and
a deadbolt strike plate implement, wherein said deadbolt strike implement is configured to accept the deadbolt of the lock mechanism.

2. The device of claim 1, further comprising a deadbolt strike plate aperture portion through which the deadbolt may enter.

3. The device of claim 2, further comprising a deadbolt strike plate projecting tab part that lines one sidewall of said deadbolt strike plate aperture portion.

4. The device of claim 3, further comprising a reinforcement plate projecting tab part that lines a sidewall of said reinforcement plate aperture portion, wherein said reinforcement plate projecting tab part interlocks with said deadbolt strike plate projecting tab part when said reinforcement plate implement is positioned between the doorjamb and the doorframe stud.

5. The device of claim 4, further comprising a set of screws operable for the mounting of the reinforcement plate implement and the deadbolt strike plate implement.

6. The device of claim 5, further comprising a plurality of reinforcement plate securing holes, wherein said plurality of reinforcement plate securing holes is configured to receive said set of screws to secure the reinforcement plate implement when said reinforcement plate implement is positioned between the doorjamb and the doorframe stud.

7. The device of claim 7, further comprising an installation template implement.

8. The device of claim 7, in which said installation template implement comprises a diagram that is configured to indicate points of screw apertures in the doorjamb, where said set of screws are installed.

9. The device of claim 8, in which said reinforcement plate implement is made with, at least one of, a carbon, a tungsten and a manganese steel alloy.

10. The device of claim 9, in which said deadbolt strike plate implement comprises at least a coating or finish that is configured to protect an appearance of said deadbolt strike plate implement.

11. The device of claim 10, further comprising a lock mechanism with a deadbolt.

12. A device comprising:
means for improving a resistance of the doorjamb from external force; and
means for accepting a deadbolt of a lock mechanism.

13. A device comprising:
a reinforcement plate implement, wherein said reinforcement plate implement is configured to position between a doorjamb and a doorframe stud, in which said reinforcement plate implement is operable for improving a resistance of the doorjamb from external force;
a projecting lip segment, wherein said projecting lip segment is configured to rest on a proximate middle portion of the doorjamb;
a reinforcement plate aperture portion, wherein said reinforcement plate aperture portion is configured to accept a deadbolt of a lock mechanism;
a deadbolt strike plate implement, wherein said deadbolt strike implement is configured to accept the deadbolt of the lock mechanism;
a deadbolt strike plate aperture portion through which the deadbolt may enter.

14. The device of claim 13, further comprising a deadbolt strike plate projecting tab part that lines one sidewall of said deadbolt strike plate aperture portion.

15. The device of claim 14, further comprising a reinforcement plate projecting tab part that lines a sidewall of said reinforcement plate aperture portion, wherein said reinforcement plate projecting tab part interlocks with said deadbolt strike plate projecting tab part when said reinforcement plate implement is positioned between the doorjamb and the doorframe stud.

16. The device of claim 15, further comprising a set of screws operable for the mounting of the reinforcement plate implement and the deadbolt strike plate implement.

17. The device of claim 16, further comprising a plurality of reinforcement plate securing holes, wherein said plurality of reinforcement plate securing holes is configured to receive said set of screws to secure the reinforcement plate implement when said reinforcement plate implement is positioned between the doorjamb and the doorframe stud.

18. The device of claim 17, further comprising an installation template implement.

19. The device of claim 18, in which said installation template implement comprises a diagram that is configured to indicate points of screw apertures in the doorjamb, where said set of screws are installed.

20. The device of claim 19, in which said reinforcement plate implement is made with, at least one of, a carbon, a tungsten and a manganese steel alloy, in which said deadbolt strike plate implement comprises at least a coating or finish that is configured to protect an appearance of said deadbolt strike plate implement.
